(19) United States
(12) Patent Application Publication
(10) Pub. No.: US 2014/0068761 A1
(43) Pub. Date: Mar. 6, 2014

(54) ABUSE IDENTIFICATION OF FRONT-END BASED SERVICES

(71) Applicants: Padmanaban Ragavan, Bellevue, WA (US); Dinesh Rajurs, Redmond, WA (US); Uma Shankar Venkata Stanam, Sammamish, WA (US); Michael Sitler, Edmonds, WA (US)

(72) Inventors: Padmanaban Ragavan, Bellevue, WA (US); Dinesh Rajurs, Redmond, WA (US); Uma Shankar Venkata Stanam, Sammamish, WA (US); Michael Sitler, Edmonds, WA (US)

(73) Assignee: MICROSOFT CORPORATION, Redmond, WA (US)

(21) Appl. No.: 13/605,696

(22) Filed: Sep. 6, 2012

(51) Int. Cl. G06F 21/00; G06F 15/173

(52) U.S. Cl. 726/22

(57) ABSTRACT

Systems and techniques of monitoring, detecting and handling abusive client behavior among data communication to and from a server system is presented. In one embodiment, a method for detecting and handling abusive client comprises: monitoring communications traffic between said server and said client; testing said traffic for abusive activity substantially in real-time; and if abusive activity has been detected, taking action against said abusive activity within a desired time period. In another embodiment, a server system comprises: a capture module that captures data between said server and a client; a package module that packages the said captured data; an analyze data module that detects abusive activity within said captured data; and a recommendations and/or actions module to perform actions in response to said abusive activity.

### BACKGROUND

Attacks on web-connected servers are known in the art. One such attack occurs when clients try to abuse server resources by using an SSL renegotiation attack. Such an attack attempts to reduce the web servers' resources to handle and service legitimate client requests.

This type of attack typically involves connecting to the server using SSL v3 or TLS v1 and not sending any actual data to the server. Thus, there may be a complete and valid SSL handshake; but with no data packets, which results in the server holding the connection until timeout.

Other types of clients may exhibit other “abusive” behavior towards a system that it may be desirable to detect, identify and handle. For example, spamming and phishing may be other types of suspicious and/or abusive activities. For the purposes of the present application, “abusive” clients and/or behavior may comprise any such suspicious and undesirable requests offered to a system and/or server.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and techniques of monitoring, detecting and handling abusive client behavior among data communication to and from a server system is presented. In one embodiment, a method for detecting and handling abusive client comprises: monitoring communications traffic between said server and said client; testing said traffic for abusive activity substantially in real-time; and if abusive activity has been detected, taking action against said abusive activity within a desired time period. In another embodiment, a server system comprises: a capture module that captures data between said server and a client; a package module that packages the said captured data; an analyze data module that detects abusive activity within said captured data; and a recommendations and/or actions module to perform actions in response to said abusive activity.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 depicts one embodiment of conventional data traffic emanating from a legitimate client to a server.

FIG. 2 depicts one embodiment of conventional data traffic emanating from a malicious client to a server.

FIG. 3 is one embodiment of one server complex comprising modules for detecting and/or managing malicious data traffic as made in accordance with the principles of the present application.

FIG. 4 is one embodiment of a flowchart of detecting and/or managing malicious data traffic as made in accordance with the principles of the present application.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### Introduction

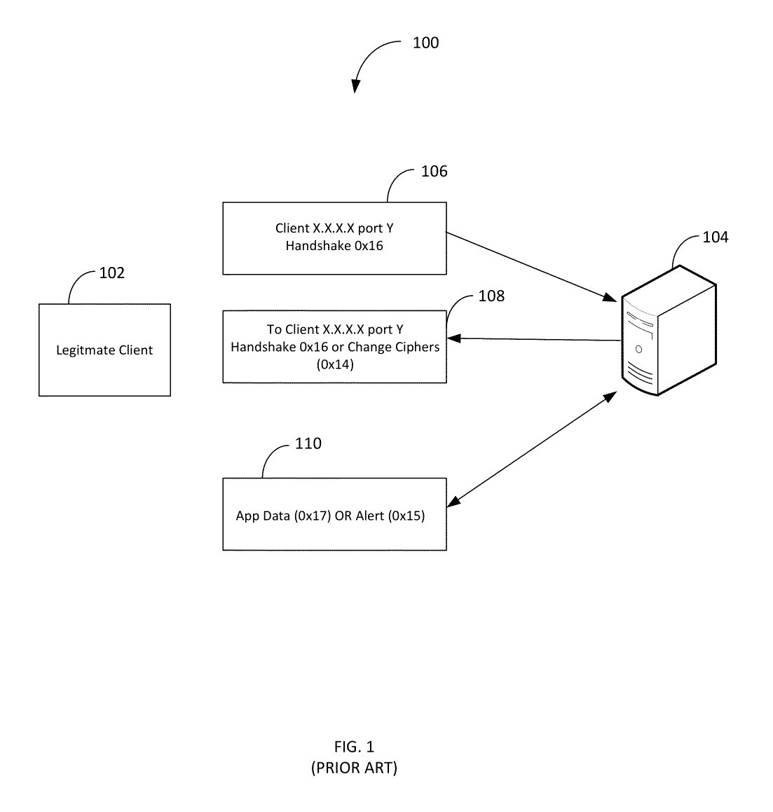

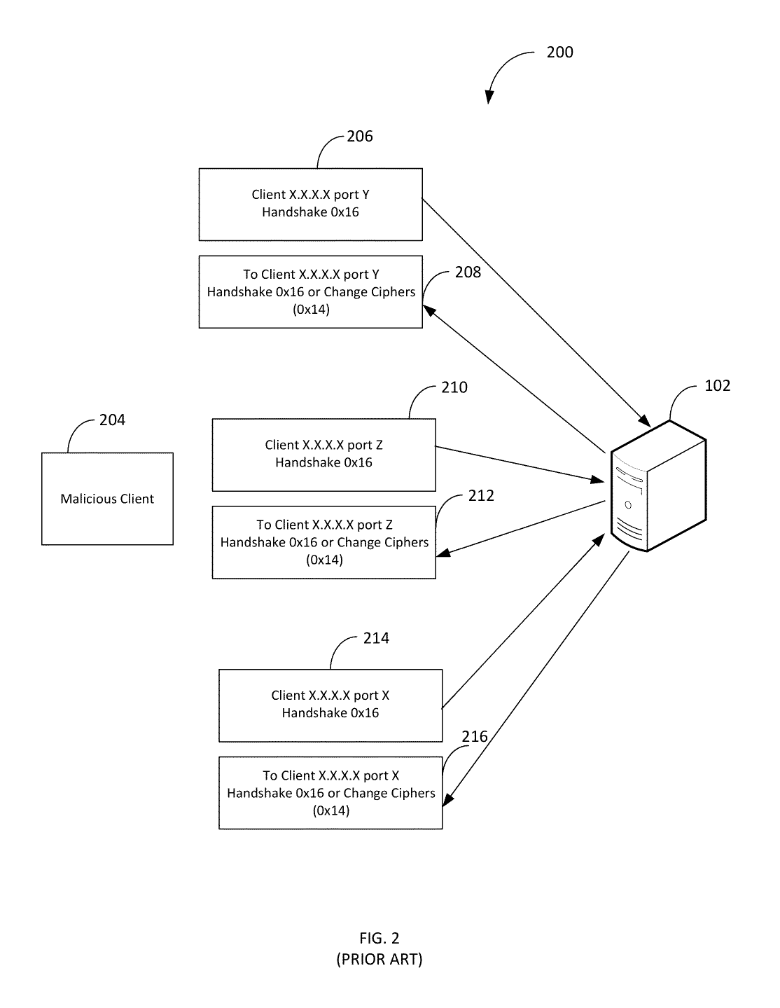

FIGS. 1 and 2 are two paradigm examples of legitimate and malicious clients who are requesting access to a server and/or website, respectively. In FIG. 1, legitimate client 102 requests service in a sequence of communications (100) from server 104. Typically, client 102 may initiate a handshake 106 with server 104, identified as Client (e.g., Client x.x.x.x over port Y, where the x's may be some possible, different, numeric values). In response, server 104 may acknowledge the requested handshake and engage in an exchange of ciphers in order to facilitate communications with client 102. Thereafter, application data and/or alerts may be passed between client 102 and server 104 at 110.

By contrast, FIG. 2 typifies a scenario whereby a malicious client is attempting to bog down the performance of a server with some type of attack (e.g. denial of service or the like). In this case, malicious client 204 is attempting to overwhelm server 102 with a number of requests for communications (e.g., in a small time period). For example, multiple requests for handshakes (i.e. 206, 210 and 214) may be made—possibly over many ports—and server 102 may respond to these requests with acknowledgement of handshake and an exchange of ciphers to effect communications (i.e., 208, 212 and 216). By this manner, malicious client 204 may either significantly slow down the performance of server 102—or may effective cause server to cease communications with other legitimate clients, as seen by other clients in requesting access.

### ONE EMBODIMENT

In one aspect of the present application, clients may try to abuse server resources by using—e.g., an SSL renegotiation attack and thereby reducing the web servers resources to service legitimate client requests. In this case, it may be desirable that the system—made in accordance with the present application—monitor the SSL handshake messages in real-time and detect the abuse. One such type of attack may involve connecting to the server using SSL v3 or TLS v1 and not sending any actual data to the server. Thus, the system may experience a complete and valid SSL handshake—with no data packets—which may result in the server holding the connection until timeout. Thus, it may be desirable to have near real-time identification solutions to attacks, e.g., such SSL renegotiation attacks.

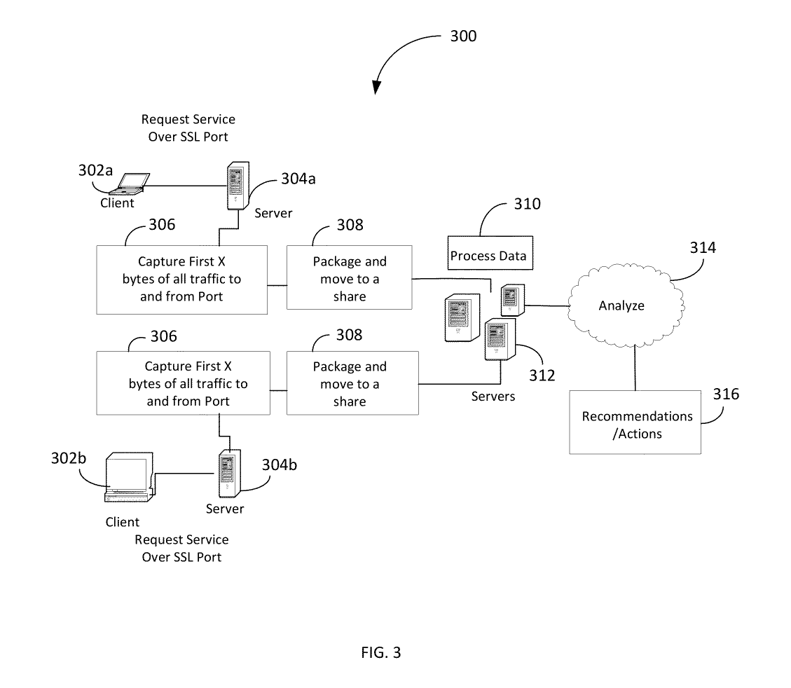

FIG. 3 is one embodiment of a system (300) made in accordance with the principles of the present application. In one embodiment, system 300 may comprise a plurality of servers 304a, 304b and/or 312 and a plurality of modules (e.g., software under control of a processor(s)—perhaps processors resident on servers 312, or other suitable processors). Servers 304a and 304b may be servers that reside on the front-end of the system and may be in communication with clients and/or other computers/processors requesting communications and/or servers from the system. It will be appreciated that the present application contemplates many different configurations of servers or processors in communications with clients/other computers—and that the present application is not limited to the architecture shown herein.

In this embodiment, one or many clients 302a and/or 302b may be in communications with the system via servers 304a and/or 304b. It is not known apriori by the system as to which client may be legitimate or malicious—and so the system may proceed to in real-time to offer protections against such malicious clients. In one embodiment, clients may request service over any potential SSL port available from the system.

Once communications has been established by the servers 304a and/or 304b, system 300 may capture the first set of bytes from all the traffic to and/or from the port at module 306—to which is connected a given client. The system, in turn, may package these bytes of traffic and move them to a share storage and/or platform via module 308. These packages may be processed (via module 310) upon the same or different set of servers and/or processors 312.

As the data is being processed, an analyze module 314 may be running—either synchronously or asynchronously—with the data processing module 310. Based upon the analysis performed by module 314, a recommendation/action module 316 may submit recommendation for actions to be taken (or take action itself)—either by an administrator, or by independent and autonomous action by the system itself.

In other embodiments, it is possible to run the modules in real-time, near real-time or every desired time period. For example, in one embodiment, it is possible that modules 306 and/or 308 may be run in real-time or substantially real-time—as the data traffic is flowing both into and from the system. The Process Data 310 may be run in near real-time processing, in order to provide timely detection of potential malicious behavior by one or more clients. The Analyze and Recommendations/Actions modules 314 and 316, respectively, may be run either real-time, near real-time or every desired time period (according to various parameters, e.g., the run time behavior of the system, the frequency of attempted attacks or the like).

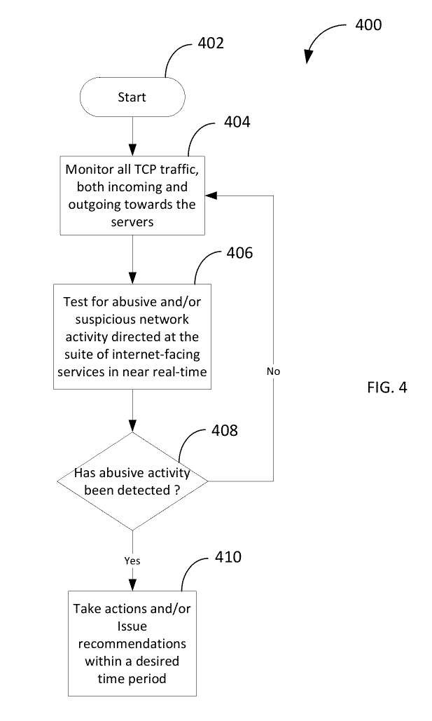

FIG. 4 is one embodiment of a procedure (400) for detecting and responding to malicious activity within substantially real-time basis. It will be appreciated that the system may have a dynamic aspect to the timing of responding to potential attacks, depending on the nature and/or scale of the attack.

Procedure 400 may start (402) by monitoring all traffic—e.g. TCP traffic, both incoming and outgoing from the system at 404. The system may test for malicious and/or suspicious activity at 406 at near real-time or desired time periods and perform a decision branch (408) as to whether such activity is positively identified. If not, the system continues on (and, in some embodiments, monitoring is continuous in time) with its active monitoring at 404. Alternatively, the system may take actions and/or issue recommendations at 410.

### ADDITIONAL EMBODIMENTS

While the system is monitoring and/or detecting abusive, malicious and/or suspicious network activity directed at a suite of internet-facing services, such activity may be detected by noting malformed and/or prematurely terminated requests—among other forms of abuse detected by the respective services. In one embodiment, the system may further comprise a scalable data pipeline and distributed computing platform to detect abuse in real time across all of the servers and issue blocks to the front-end servers. Actions in response may comprise the following: logging SSL requests, and/or issuing blocks specific to SSL-detected abuse.

### Capture

In some embodiments, capturing raw network logs may be done using NMcap.exe or WinDump.exe (e.g., using WinpPCap libraries) or by a proprietary tool that uses raw windows sockets. Irrespective of the way the packets are captured, it may be desirable to capture the traffic to and from SSL port continuously and drop it as PCAP files either on a local folder or a network share. It will be appreciated that data may be in any suitable format for the purposes of the present application.

In one embodiment, it may suffice only to capture the headers and possibly ignore the remaining data. In one particular embodiment, it may be sufficient to capture substantially only a first portion (e.g., the first 80 bytes) of each packet and log it. In addition, it may be sufficient in some embodiments to capture traffic on a desired percentage of the servers in each environment.

In one specific embodiment, the system may use the WinDump utility or some suitable logging utility to capture first 80 bytes of all traffic to and from port 443.

### Package

In one embodiment, it may be desired to package the logs either in pcap format or some suitable pre-processed format to a network share. If there is no pre-processing involved, the logs may be simply compressed and moved to a network share.

Alternatively, if there is some pre-processing done (which may depend, e.g., on the load of the server(s)), the pcap files may be opened and, for each packet, it is possible to extract a subset of information, e.g., the following information: Source IP, Source Port, Destination IP, Destination Port, SSL header type, Timestamp (henceforth called as “protocol fragments”). This information may be logged as a TSV file in a local path. Once the file is pre-processed, it may be compressed and moved to the network share. In one particular embodiment, the pre-processing may be done as a part of Packaging.

### Processing

In one embodiment, it may be desired to use a highly scalable data pipeline to upload/pre-process these logs into a distributed computing platform. If the logs were already pre-processed in the packaging step, then this step may only un-compresses them and upload them to a Big Data solution. Otherwise, it is possible that this step does the pre-processing (as explained above)—in addition to uploading data.

### Testing/Analysis

In some embodiments, having the data from all the servers as described above into a distributed computing platform, the system may proceed to test and/or mine the data. Since the big data solution is designed to solve for latency and scale, it may be possible to process large volumes of protocol fragments records with low latency. In one embodiment, a system may affect different types of testing and/or analysis on these protocol fragments. It will be appreciated that the system need not be architected into a distributed computing platform; but any suitable server architecture may suffice.

For example, in one embodiment, it is possible to use the protocol fragments to determine the IPs that have never sent the system a message with any application data. For example, for all valid SSL requests, there will be messages with the following type 0x16 (SSL3_RT_HANDSHAKE), or 0x14 (SSL3_RT_CHANGE_CIPHER_SPEC) and should include in the message chain a 0x15 (SSL3_RT_ALERT), or 0x17 (SSL3_RT_APPLICATION_DATA).

A message with SSL3_RT_APPLICATION_DATA indicates that the client is sending the server or the server is sending the client actual data used by the service. It is possible to analyze the captured or otherwise gathered data to find the clients and/or IPs that almost never send the system “application data”—e.g., a message of type “Application” data. In one embodiment, this might comprise an “Interesting” list and/or set of clients and/or IPs. In this set, it may be possible to find clients and/or IPs that have contacted the servers (or otherwise exhibit suspicious behavior) over more than a desired threshold (e.g., a number of contacts, an amount of time for not sending application data, or the like) and this may form a “Suspicious” list and/or set.

### Recommendations

Based on the output from the Analysis step, it may be possible to make various recommendations or take various actions. For some examples, recommendations and/or actions may comprise (but not limited to) the following:
(1) Make Network and Application recommendations.
(2) Block these IPs for a reasonable amount of time so that they do not reach the servers.
(3) Re-Route—Re-Route incoming connections from these IPs to a different server.
(4) Increase logging to and from a set of IPs.

In addition, the system may attempt to discern what these IPs are trying to accomplish. For example, the system could attempt to see if these IP are sending the system data. If so, what are these IP attempting to access? Answers to such questions may go back to the Analysis step where additional algorithms try to find answers for these questions.

### Improved System Intelligence

In some embodiments, tracking data sent from IPs in the Suspicious set may prove valuable, as such IP may be trying to access Phish or Malware sites and hence it could be used to detect such sites.

In some embodiments, many of these IPs seem to be associated with downloading/accessing Malware/Phish related content and could be involved in gauging the system algorithms' effectiveness and hence the system may use this to protect these algorithms against gaming by detecting and blocking them.

Another aspect to suspicious behavior is “spam”. The IPs that exhibit “suspicious” behavior over multiple days seem to have a high degree of association with sending “spammy” email. By treating all mails sent from these IPs as Spam, it may be possible to reduce Spam with a low percentage of false positives.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. In a system comprising a server and a communication connection available for a client to connect to said server and said client to request service from said server, a method for detecting and handling abusive client, the steps of said method comprising:
monitoring communications traffic between said server and said client;
testing said traffic for abusive activity substantially in real-time;
if abusive activity has been detected, taking action against said abusive activity within a desired time period.

2. The method of claim 1 wherein the step of monitoring communications traffic further comprises:
capturing raw network logs; and
packaging said raw network logs.

3. The method of claim 2 wherein said step of capturing raw network logs further comprises:
capturing the traffic to and from an SSL port.

4. The method of claim 3 wherein the step of capturing the traffic to and from an SSL port further comprises:
capturing substantially only a first portion of said traffic.

5. The method of claim 3 wherein the step of capturing the traffic to and from an SSL port further comprises:
capturing traffic only from a desired percentage of the servers in said system.

6. The method of claim 4 wherein said first portion comprises the first 80 bytes of a packet and said first portion is captured by a desired logging utility.

7. The method of claim 2 wherein the step of packaging said raw network logs to a network share further comprises:
packaging said raw network logs to a suitable pre-processing format.

8. The method of claim 7 wherein the step of packaging said raw network logs to a suitable pre-processing format further comprises:
extracting protocol fragments from said pre-processed logs.

9. The method of claim 8 wherein said protocol fragments comprises one of a group, said group comprising: Source IP, Source Port, Destination IP, Destination Port, SSL header type and Timestamp.

10. The method of claim 1 wherein the step of the step of testing said traffic for abusive activity substantially in real-time further comprises:
analyzing data captured from clients; and
placing clients that almost never send application data on an “interesting” list.

11. The method of claim 10 wherein the step of testing said traffic for abusive activity substantially in real-time further comprises:
placing clients on a “suspicious” list if said clients exhibit suspicious behavior over a desired threshold.

12. The method of claim 1 wherein the step of taking action against said abusive activity within a desired time period further comprises:
taking one of a group of actions, said group comprising: make recommendations, block a set of IPs, re-route traffic from a set of IPs and increase logging to and from a set of IPs.

13. The method of claim 12 wherein said step of taking action against said abusive activity within a desired time period further comprises:
tracking data from a set of IPs to detect a group of suspicious activity, said group comprising: malware, phishing, spamming.

14. A server system that monitors and handles abusive client behavior, said system comprising:
a set of servers, said servers capable of communications with a set of clients, said clients capable of requesting communications and services from said set of servers;
a capture module, said capture module capable of capturing data between said server and a client;
a package module, said capture module capable of packaging said captured data;
an analyze data module, said analyze data module capable of detecting abusive activity within said captured data; and
a recommendations/actions module to perform one of a group, said group comprising: recommendations for action and actions in response to said abusive activity.

15. The server system of claim 14 wherein said capture module and said package module is capable of operating in substantially real-time.

16. The server system of claim 15 wherein said analyze data module is capable of operating in substantially near real-time.

17. The system of claim 16 wherein said recommendation/action module is capable of operating on a desired time period.

18. A computer readable storage medium that is not a transient signal, said computer readable storage medium having computer-executable instructions stored thereon that, when executed by a processor, cause said processor to execute: a method for detecting and handling abusive client, the steps of said method comprising:
monitoring communications traffic between said server and said client;
testing said traffic for abusive activity substantially in real-time;
if abusive activity has been detected, taking action against said abusive activity within a desired time period.

19. The computer readable storage medium of claim 18 wherein said the step of monitoring communications traffic further comprises:
capturing raw network logs; and
packaging said raw network logs.

20. The computer readable storage medium of claim 19 wherein the step of the step of packaging said raw network logs to a network share further comprises:
packaging said raw network logs to a suitable pre-processing format; and
extracting protocol fragments from said pre-processed logs.
